(19) United States
(12) Patent Application Publication
(10) Pub. No.: US 2007/0248354 A1
(43) Pub. Date: Oct. 25, 2007

(54) Lens exchanger apparatus

(76) Inventor: Richard B. Hetnarski, Naples, FL (US)

Correspondence Address: JAECKLE FLEISCHMANN & MUGEL, LLP, 190 Linden Oaks, ROCHESTER, NY, 14625-2812, US

(21) Appl. No.: 11/411,166

(22) Filed: Apr. 25, 2006

(51) Int. Cl. G03B 19/00

(52) U.S. Cl. 396/429

(57) ABSTRACT

An apparatus for exchanging a detachable lens in a camera with another lens includes a pair of flexible gloves that are sealably attached to a portable glove box, thereby providing a hermetically sealable enclosure into which the camera and lenses can be inserted and from which they can be withdrawn. An electrically powered air cleaner located within the portable glove box removes dust particles from air within the glove box while the camera and said lenses are sealably enclosed therein, thus preventing contamination of the camera by dust particles during exchange of the lenses.

### FIELD OF THE INVENTION

The present invention relates to glove boxes and, more particularly, to an apparatus that includes a glove box for enabling the exchange of lenses on cameras in a sealed environment of cleaned air.

### BACKGROUND OF THE INVENTION

For many years, dust and other air pollutants have been considered to be critical and annoying problem during lens changes of a camera, since they contaminate the film in film cameras or the electronic sensors in digital cameras. This matter has been particularly acute when dealing with delicate electronic sensors of digital cameras with detachable lenses, such as SLR (Single Lens Reflex) digital cameras and range finder digital cameras, where the sensors, which typically are of small dimensions compared with a film frame, are continually exposed to air. In film cameras, this danger is diminished by the fact that the film progresses in the camera as consecutive pictures are taken. Even if there is a contamination of one frame, the following frames are not exposed to the same danger.

In a digital camera, the effects of dust contamination are especially serious because the charged surface of the sensor tends to attract dust particles. Because of the particular danger of contamination of electronic sensors in digital cameras by dust and other air pollutants, some photographers carry two cameras, each with a different lens, to avoid the changing of lenses in the field, and thus, to avoid the possibility of dust getting inside the camera during the lens changes. If dust contamination occurs, professional cleaning may be required.

Various methods and devices for cleaning cameras and lenses are described in the following U.S. Patent Application Publications, the disclosures of which are incorporated herein by reference: Ichikawa, US 2005/0129394 A1 of Jun. 16, 2005 Cleaning Apparatus for Camera; Sugihara, US 2004/0200027 A1 of Oct. 14, 2004, Image-Device Cleaning Apparatus; Arai, US 2005/0275738 A1 of Dec. 15, 2005, Digital Camera and Cleaning Apparatus Therefore; Nonaka, US 2005/0104997 A1 of May 19, 2005, Lens Replacement Type Imaging Apparatus, Control Apparatus, Cleaning Apparatus, and Cleaning Method.

Recently, at least one camera manufacturer introduced a so-called Supersonic Wave Dust Reduction Filter, which employs supersonic vibration to shake off dust that might spoil photographic images. Most camera manufacturers, however, do not use such devices, so millions of digital SLR cameras in current use are not equipped with them. Many photographers using digital SLR or digital rangefinder cameras deal with the problem of images affected by dust-contaminated sensors by performing software manipulation while printing photographs, but this method is cumbersome and time-consuming.

The present invention is directed to a glove box provided with an electric air cleaner for use in changing the lenses of a camera. A glove box is a common type of isolation enclosure well known in the prior art. At least three types of systems employing glove boxes are known: filter systems, negative systems, and positive systems. Filter systems are those connected to the ambient air by filters. Negative systems are those employing an isolated atmosphere at negative pressure in order to prevent the escape of dangerous materials. Positive systems are those having an isolated atmosphere at positive pressure to prevent the action of ordinary air on reactive materials inside the glove box.

In certain industries such as the nuclear industry or the pharmaceutical industry, filter systems are used to isolate manufacturing processes from the ambient air, either to prevent the propagation of contaminant products into the atmosphere, or to prevent the introduction of pollutants contained in the atmosphere into the place where the manufacturing process is being performed. For certain purposes such as, for example, the manipulation of radioactive materials, the glove box may be required to have protective walls, and may be equipped with other devices such as vacuum pumps or high-pressure pumps.

A glove box typically consists of an isolated chamber with transparent walls, and openings, or ports, to which gloves are attached. An operator, by putting his hands inside the glove box through the gloves, is able to perform needed manipulations inside the isolated chamber.

The following U.S. Patents, the disclosures of which are incorporated herein by reference, relate to the construction and use of glove boxes: Van Der Waij et al., U.S. Pat. No. 3,777,736 of Dec. 11, 1973, Transporter for Substantially Germfree Transport of Big Living Organisms; Pruchon, U.S. Pat. No. 4,704,951 of Nov. 10, 1987, Ventilation System for an Isolation Enclosure; Thomas et al., U.S. Pat. No. 5,083,558 of Jan. 28, 1992, Mobile Surgical Compartment with Micro Filtered Laminar Air Flow; Dicciani et al., U.S. Pat. No. 5,257,957 of Nov. 2, 1993, Facility for Providing a Sealed Work Area to Handle, Manipulate and Formulate Materials; Browning, U.S. Pat. No. 6,149,252 of Nov. 21, 2000, Glove Box for Cutting a Hole in a Ceiling; Henry et al., U.S. Pat. No. 6,974,197 B1 of Dec. 13, 2005, Portable Glovebox and Filtration System.

There are numerous methods of attachment of gloves at ports, depending on the intended purpose of a particular glove box. Examples of the construction of port/glove seals or port/sleeve seals are presented in the following U.S. Patents, the disclosures of which are incorporated herein by reference: Grieb, U.S. Pat. No. 2,600,240, filed May 22, 1948, Construction of Incubators for Infants; Eisert, U.S. Pat. No. 4,010,588, of Mar. 8, 1977, Sealing device; Eisert, U.S. Pat. No. 4,141,609, of Feb. 27, 1797, System for Effecting Access into Sealed Enclosures; Picco, U.S. Pat. No. 5,299.243, of Mar. 29, 1994, Glove Holder Unit for a Confinement Enclosure; Jennrich et al., U.S. Pat. No. 5,662,581, of Sep. 2, 1997, Easily Sterilizable Glove System.

### SUMMARY OF THE INVENTION

In accordance with the present invention, an apparatus for exchanging a detachable lens in a camera with another lens includes a pair of flexible gloves that are sealably attached to a portable glove box, thereby providing a hermetically sealable enclosure into which the camera and lenses can be inserted and from which they can be withdrawn. The improvement comprises an electrically powered air cleaner located within the portable glove box to remove dust particles from air within the glove box while the camera and said lenses are sealably enclosed therein, thus preventing contamination of the camera by dust particles during exchange of the lenses.

### BRIEF DESCRIPTION OF THE DRAWINGS

FIG. 1 is a perspective view of a glove box included in one embodiment of the lens exchanger apparatus of the present invention.

FIG. 2 is a detail view of the port and the sealing of the glove in the glove box depicted in FIG. 1.

FIG. 3 is a perspective view of a glove box included in a second embodiment of the lens exchanger apparatus of the present invention, which includes three pairs of gloves attached to the glove box walls.

FIG. 4 is a perspective view of a glove box included in a third embodiment of the lens exchanger apparatus of the present invention, which includes an internal shelf and two pairs of gloves attached to the glove box walls at differing heights.

FIG. 5 is a perspective view of a glove box included in a fourth embodiment of the lens exchanger apparatus of the present invention, which includes a hinged door.

FIG. 6 is a perspective view of a glove box included in a fifth embodiment of the lens exchanger apparatus of the present invention, which includes glove box ports disposed in the lid of the glove box.

### DETAILED DESCRIPTION OF THE INVENTION

In the proposed apparatus, the air pressure and the air temperature are the same as those of surroundings, and there are no dangerous materials to deal with. However, the method of sealing of gloves at the glove box ports should allow for an easy exchange of gloves. This is achieved by providing easily removable seals made of rubber or another elastic material, assuring a convenient access to the glove box chamber while at the same time providing a sufficient degree of isolation of the inside air from the outside air.

The proposed apparatus, depending on its embodiment, is capable of dealing with one camera or a multiplicity of cameras at the same time. The apparatus for dealing with a single camera contains two glove ports, while the one for dealing with more than one camera at a time contains more than two glove box ports, which may be located either in the walls of the glove box, or in the lid of the glove box or in the detachable wall of the glove box, or in the hinged door of the glove box, or in a combination of these locations. The glove box ports may be located in a single row or in multiple rows at varying levels in the walls of the glove box. Furthermore, the glove box may contain one or more interior shelves, enabling the manipulation of cameras and lenses at various levels.

The present invention thus provides for the exchange of the lenses of film and digital cameras in an environment of cleaned air, substantially reducing the danger of dust contamination of film or electronic sensor in a camera. The apparatus of the invention is easily transportable, and the included electric air cleaner may be powered by batteries located within the glove box, by an external source of alternating current (AC), or by a low voltage direct current (DC) in, for example, an automobile. The invention eliminates or substantially reduces the danger of dust contamination of film or electronic sensors in a camera.

Removal of dust and other pollutants from air can be achieved in a variety of ways. Air cleaners suitable for use in the present invention may employ HEPA (High Efficiency Particulate Arresting) or similar filters, or adsorption filters containing activated carbon or Zeolite. Other suitable air cleaners include those that use charged plates or grids to remove dust by electrostatic precipitation. Other useful air cleaners include corona discharge devices, which remove particles by electronic plasma incineration. A combination of methods may be employed to remove dust particles in the apparatus of the present invention.

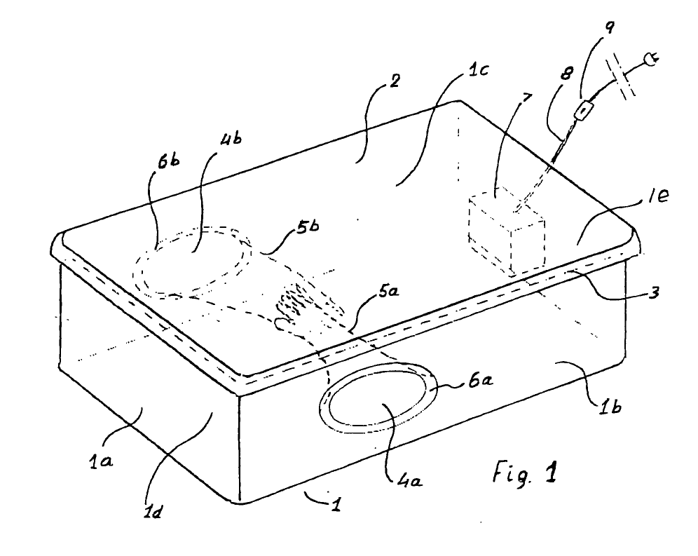

Specific embodiments of the invention described below and illustrated in FIGS. 1-6 are exemplary and cannot be considered as limiting.

Referring now to FIG. 1, there is shown one embodiment of the lens exchanger, comprising a transparent glove box 1 that comprises a substantially rectangular floor 1a attached to a front wall 1b, a rear wall 1c, two side walls 1d and 1e, and is provided with a transparent lid 2 and a seal 3 disposed between glove box 1 and lid 2. Glove box 1 includes two glove box ports, 4a and 4b, and gloves 5a and 5b are attached to ports 4a and 4b, respectively, by means of removable port/glove seals 6a and 6b, respectively. An electric air cleaner 7 is located within glove box 1, and an optional electric cord 8 that passes through side wall 1e of glove box 1 is provided with an optional external on/off switch 9.

In the embodiment presented in FIG. 1, an operator sitting at the end of glove box 1 that is opposite from electric air cleaner 7 changes a lens on a camera located in box 1 by placing his right hand into glove 5a and his left hand into glove 5b.

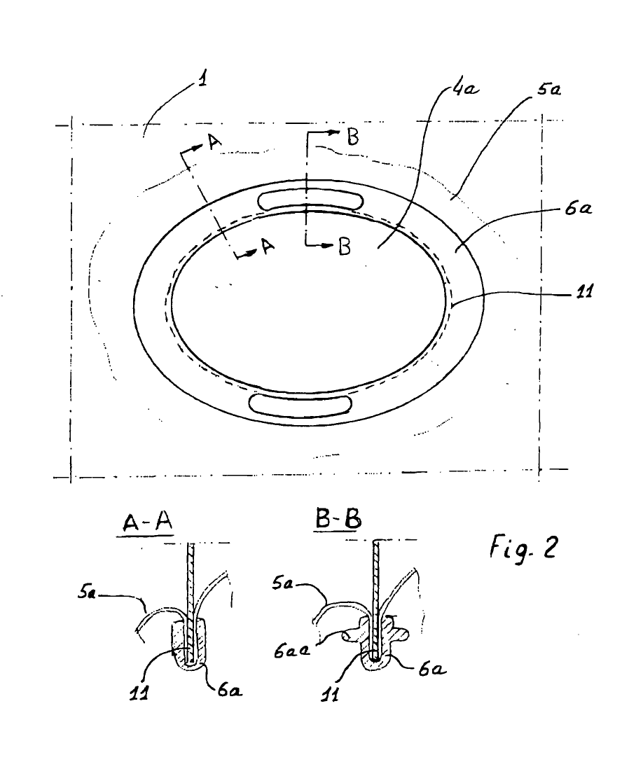

FIG. 2 is a detailed illustration of glove box port 4a of glove box 1, depicting the port/glove seal 6a attached to the rim 11 of port 4a. Seal 6a, which secures glove 5a, is of substantially constant thickness, as shown in the cross section A-A, except that it has a thickened portion 6aa along the circumference, as shown in the cross section B-B. Thickened portion 6aa facilitates the removal and reinstallation of seal 6a while changing glove 5a.

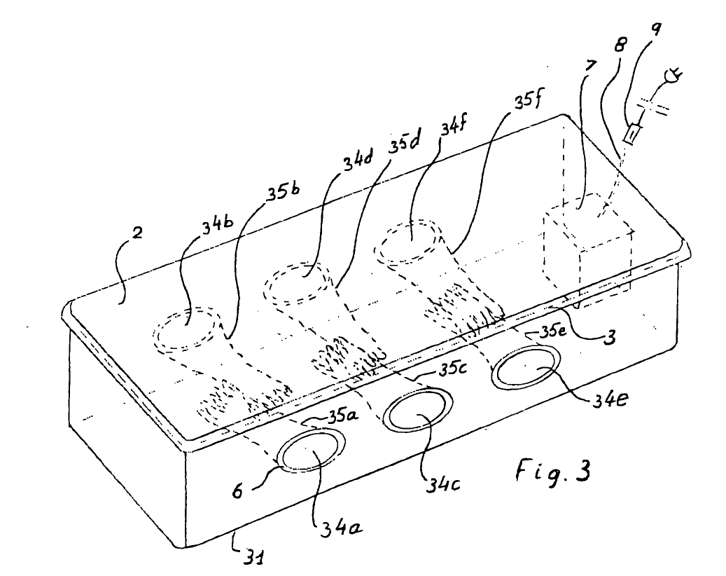

FIG. 3 shows another embodiment of the lens exchanger, useful when lenses on more than one camera are to be changed at the same time, that comprises a transparent glove box 31, lid 2 and a seal 3 disposed between glove box 31 and lid 2. Glove box 31 includes an electric air cleaner 7 provided with optional electric cord 8 and optional external on/off switch 9, and three pairs of glove ports, 34a-b, 34c-d, and 34e-f, positioned along horizontal lines on both opposite sides of glove box 31, and corresponding glove pairs 35a-b, 35c-d, and 35e-f.

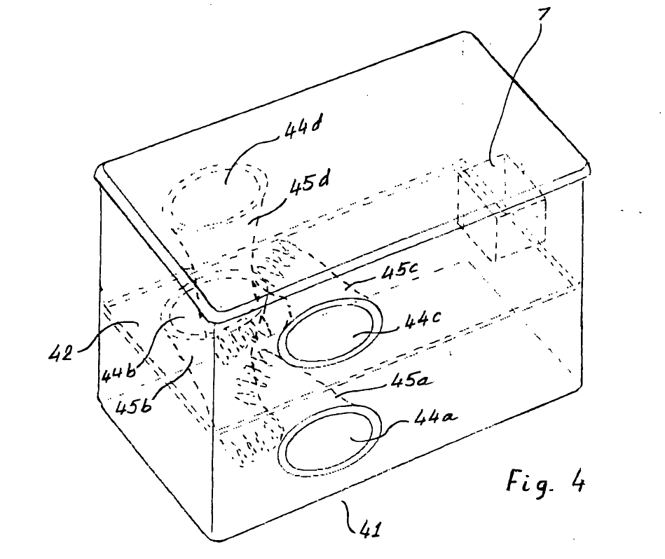

Another embodiment of the lens exchanger with more than two ports is depicted in FIG. 4, where glove box ports are placed on more than one level. Glove box 41 includes an electric air cleaner 7 and two pairs of glove ports, 44a-b and 44c-d, positioned one above the other, and corresponding glove pairs 45a-b and 45c-d. Glove box 41 further includes an internal shelf 42, which may be provided with multiple holes to facilitate air flow throughout glove box 41 during the air cleaning operation.

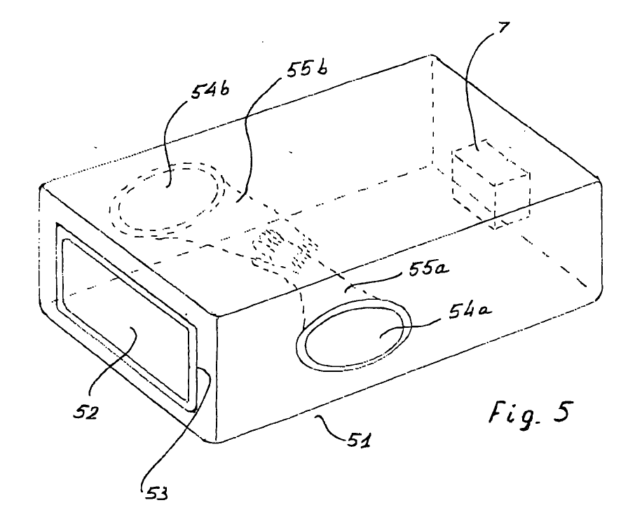

In FIG. 5 is depicted a lens exchanger of the present invention that comprises a glove box 51 containing an electric air cleaner 7 and two glove ports, 54a-b and corresponding glove pair 55a-b. Access to the interior of glove box 51 is provided by a hinged door 52 and corresponding seal 53, rather than a lid, as shown in FIGS. 1, 3, and 4.

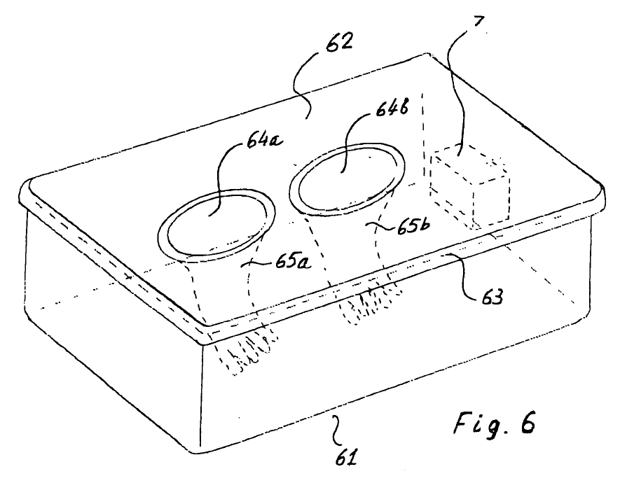

FIG. 6 illustrates an embodiment of the invention comprising a glove box 61, an electric air cleaner 7, a transparent lid 62, and a seal 63 disposed between glove box 61 and lid 62. Two glove box ports 64a-b and corresponding glove pair 65a-b are disposed in lid 62.

In accordance with added features of the invention: the method of exchanging lenses is as follows:

1) the operator opens the glove box by removing the lid, or by removing or opening a detachable wall or a hinged door;

2) the operator attaches the gloves to the ports of the glove box with the port/glove seals;

3) the operator places the camera with detachable lens together with another lens inside the glove box, and replaces the lid or closes the detachable wall or hinged door of the glove box, thereby sealing it from the outside air;

4) the operator operates the electric air cleaner for a period of time sufficient for the air cleaner to remove substantially all dust and other pollutants from the air confined within the glove box, then turns off the air cleaner;

5) the operator puts his hands through the glove box ports of the glove box into the gloves attached to the ports, removes the lens from the camera, and installs another lens on the camera inside the glove box;

6) the operator opens the glove box by removing the lid or by opening the detachable wall or the hinged door, and removes the camera and lenses.

At least a portion of the main box and the lid or detachable wall or the hinged door of the glove box is transparent, so that the operator can observe the contents during the manipulation of the camera and of the lenses. The source of energy for the electric air cleaner can be internal batteries, house electric current (AC) or the automobile battery direct current (DC). An appropriate adaptor and electrical cord may be required to operate the air cleaner with an external power source. If a cord is employed, it must be sealably attached to the glove box so that there is no exchange of air between air inside and outside of the glove box. An on/off switch to control the delivery of power to the electric air cleaner may be located either inside or, preferably, outside the glove box. The port/glove seals are made of an elastic material such as rubber, and can be easily removed and reattached when changing the gloves. Both the gloves and seals are disposable and replaceable.

While the invention has been described by reference to various specific embodiments, it should be understood that numerous changes may be made within the spirit and scope of the inventive concepts described. Accordingly, it should be recognized that the invention is not limited to the described embodiments but has full scope defined by the language of the following claims.

What is claimed is:

1. An apparatus for exchanging a detachable lens in a camera with another lens, said apparatus including a pair of flexible gloves sealably attached to a portable glove box and providing a hermetically sealable enclosure into which said camera and said lenses can be inserted and from which they can be withdrawn;
wherein the improvement comprises:
an electrically powered air cleaner located within said portable glove box to remove dust particles from air within said glove box while said camera and said lenses are sealably enclosed within said glove box, thereby preventing contamination of said camera by dust particles during exchange of said lenses.

2. The apparatus of claim 1 wherein said air cleaner is powered by at least one battery located within said glove box, delivery of power from said battery to said air cleaner being controlled by an on/off switch.

3. The apparatus of claim 1 wherein said air cleaner is powered by an external power source that is an alternating current (AC) source or a direct current (DC) source, delivery of power from said power source being controlled by an on/off switch.

4. The apparatus of claim 1 wherein said glove box comprises a hermetically sealable enclosure encompassed by a substantially rectangular floor attached to a front wall, a rear wall, two side walls, and a substantially rectangular lid that is sealably attachable to said walls.

5. The apparatus of claim 4 wherein at least a portion of said lid is detachable from said walls to provide access to said enclosure.

6. The apparatus of claim 4 wherein at least a portion of at least one of said walls is detachable from said glove box to provide access to said enclosure.

7. The apparatus of claim 4 wherein said glove box further comprises a sealable hinged door for providing access to said enclosure.

8. The apparatus of claim 7 wherein said hinged door is located in at least one of said walls or in said lid.

9. The apparatus of claim 4 wherein at least a portion of one of said walls or at least a portion of said lid is constructed from a transparent material.

10. The apparatus of claim 9 wherein said four walls and said lid are constructed from said transparent material.

11. The apparatus of claim 4 wherein said pair of gloves is sealably attached to ports in said front wall.

12. The apparatus of claim 4 wherein one glove of said pair of gloves is sealably attached to a port in said front wall, and the other glove of said pair of gloves is sealably attached to a port in said rear wall.

13. The apparatus of claim 4 wherein said pair of gloves is sealably attached to ports in said lid.

14. The apparatus of claim 4 further comprising a plurality of glove pairs.

15. The apparatus of claim 14 wherein said plurality of glove pairs are sealably attached to said front and rear walls at ports at varying heights from said floor.

16. The apparatus of claim 14 wherein said plurality of glove pairs are sealably attached to ports in said lid and/or in at least one of said walls.

17. The apparatus of claim 1 wherein each glove of said pair of gloves is sealably attached to a port in said glove box by a port seal.

18. The apparatus of claim 17 wherein each said glove and/or each said port seal is replaceable.

19. The apparatus of claim 1 further comprising at least one shelf disposed within said glove box.

20. The apparatus of claim 1 wherein said electric air cleaner is selected from the group consisting of a HEPA filter device, an electrostatic precipitation device, a corona discharge device, and combinations thereof.
